(19) United States
(12) Patent Application Publication
(10) Pub. No.: US 2006/0037998 A1
(43) Pub. Date: Feb. 23, 2006

(54) Thermally-controlled actuator device

(76) Inventors: Stephane Crabol, Toulouse (FR); Guy Valembois, Blagnac (FR); Patrick Poveda, Frouzins (FR)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/256,508

(22) Filed: Oct. 21, 2005

(30) Foreign Application Priority Data
Jan. 26, 2004 (FR) 0400716

(51) Int. Cl. B23K 31/02

(52) U.S. Cl. 228/234.3

(57) ABSTRACT

The present invention relates to a thermally-controlled actuator device of the type comprising a body, a part held stationary relative to the body by a low-melting point connection material, e.g. brazing or equivalent means, and a mass of exothermic material suitable for acting on command to give off intense heat energy suitable for melting the connection material so as to release the part relative to the body, wherein the exothermic material is housed in a chamber that is subdivided into a plurality of compartments suitable for confining said material in close thermal contact with the wall of the chamber.

The present invention relates to the field of thermally-controlled actuator devices.

More precisely, the present invention relates to the field of devices comprising a body, a part held stationary relative to the body by a low-melting point connection material, e.g. brazing or equivalent means, and a mass of exothermic material suitable for acting on command to give off intense heat energy suitable for melting the connection material so as to release the part relative to the body.

### BACKGROUND OF THE INVENTION

Various devices of the above-specified type have already been proposed.

An example of such devices is to be found in document FR-A-2 806 788.

A particular application of the present invention lies in the aerospace domain, in particular for implementing a variety of equipments on satellites, such as deploying solar panels or releasing specific elements.

Known devices of the above-specified type have already given good service.

Nevertheless, it turns out that their operation under particular conditions of acceleration, gravity, or weightlessness, does not always give satisfaction.

The Applicant has found in particular that in certain configurations, known devices do not always enable the part that is held stationary to be released in satisfactory manner.

### OBJECTS AND SUMMARY OF THE INVENTION

The main object of the present invention is to propose a novel thermally-controlled actuator device which enables the drawbacks of the prior art to be eliminated.

This object is achieved in the present invention by a thermally-controlled actuator device of the above-specified type in which the exothermic material is housed in a chamber that is subdivided into a plurality of compartments suitable for confining said material in close thermal contact with the wall of the chamber.

In a first embodiment in accordance with the present invention, the chamber is constituted by a housing formed in a main body and subdivided by a plurality of disks or cups.

In a second embodiment in accordance with the present invention, the chamber is constituted by a plurality of wells formed in the main body.

### BRIEF DESCRIPTION OF THE DRAWINGS

Other characteristics, objects, and advantages of the present invention appear on reading the following detailed description and from reference to the accompanying drawings given as non-limiting examples, and in which:

FIG. 1 is a diagrammatic view of a thermally-controlled actuator device known in the state of the art;

FIG. 2 shows a first embodiment of the chamber in accordance with the present invention, subdivided by a plurality of disks or cups; and

FIGS. 3, 4, and 5 are respectively a perspective view, a section view, and a face view of a chamber constituting a second embodiment of the present invention.

### MORE DETAILED DESCRIPTION

FIG. 1 shows a conventional device known in the prior art to which the present invention can be applied.

In FIG. 1, there can be seen a known actuator device comprising a body 10 defining a chamber 20 housing a mass 30 of exothermic material, associated with initiators 40, 42 and a ring (e.g. a stainless steel ring) 50 fixed at 60 by means of a low-melting point material (preferably brazing) to the body 10, and suitable for activating a member 70 on being released.

Such a device is known in the state of the art, in particular from document FR-A-2 806 788. It is therefore not described in greater detail below.

After much testing and analysis, the Applicant has nevertheless found that the deficiencies observed under the particular operating conditions mentioned above stem a priori from the fact that under such conditions heat exchange between the exothermic mass and the body is not sufficient to melt the bonding material (the brazing).

Still more particularly, the Applicant has found that the relative loss of heat exchange, compared with behavior under conventional test conditions, generally stems from poor contact between the wall of the chamber and the exothermic mass. This poor contact generally comes either from the exothermic material flowing under the effect of external forces (gravity, acceleration), or else from internal forces due to behavior in weightlessness (surface tension), aggregated by a loss of volume of the material during its reaction, in particular when it is a chemical composition of the thermite type.

As mentioned above, in order to solve this difficulty, the Applicant proposes subdividing the chamber housing the exothermic material into a plurality of compartments suitable for confining said material in close thermal contact with the wall of the chamber.

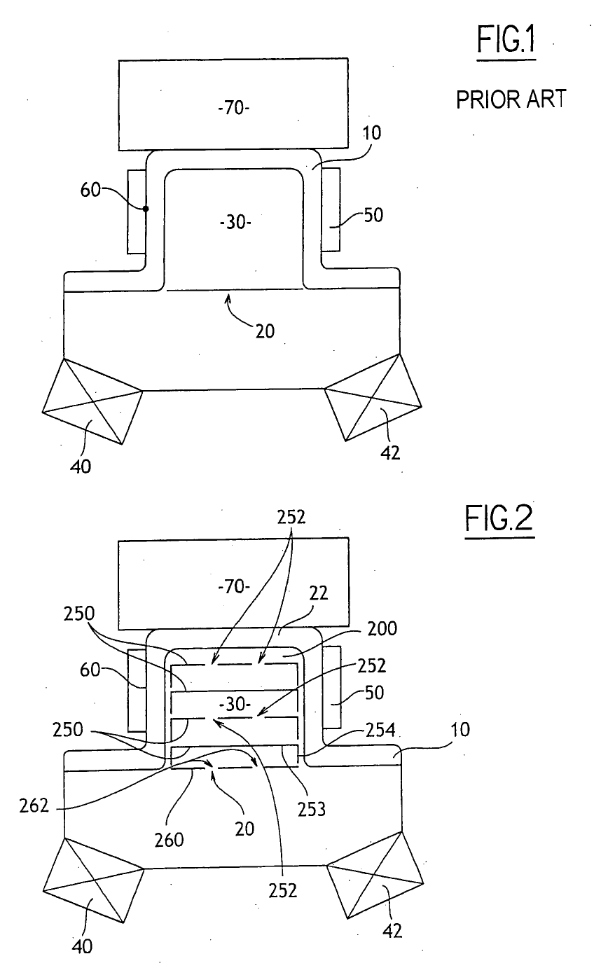

More precisely, in a first embodiment of the present invention, shown in accompanying FIG. 2, the chamber 20 is constituted by a housing 200 formed in a main body 10 and subdivided by a plurality of disks or cups 250.

Still more precisely, in this embodiment, a plurality of cups 250 are preferably provided that are stacked at respective distances parallel to the end wall 22 of the chamber 20, together with a closure disk 260 which covers the outline of the opening of the chamber.

Typically, four cups 250 can thus be provided together with one disk 260. The disk 260 serves to “close” the chamber.

The section of each cup 250 and of the disk 260 is complementary to that of the chamber 20.

Each cup 250 is itself preferably constituted by a disk 253 carrying at its periphery a cylindrical collar 254 of height corresponding to the desired spacing between the cups 250.

Each cup 250 and the disk 260 preferably includes at least one through passage for transmitting initiation from an individual mass of the exothermic material 30 to an adjacent individual mass. Two diametrically-opposite passages 252 and 262 are preferably provided through each cup 250 and the disk 260, said passages 252 and 262 being angularly offset from one cup to the next so as to form a baffle for confining the exothermic material. Typically, but in non-limiting manner, these passages 252, 262 have a diameter of 1.5 millimeters (mm) and they are positioned on a diameter of 9 mm, passing through the walls of the cups 250 and the disk 260 which are of a thickness of 0.5 mm.

The cups 250 and the disk 260 may be made of any material that is a good conductor of heat and that presents a melting point that is higher than the operating temperature of the exothermic material.

By way of example, the material may be titanium or a copper/tungsten mixture, e.g. Cu28/W72. This mixture presents excellent thermal diffusivity (ratio of conductivity divided by specific heat). This characteristic ensures very good transfer of heat from the composition in combustion to the inside wall of the chamber (and thus to the brazed connection).

The body 10 may itself be formed out of any suitable material, for example a material based on stainless steel, copper/tungsten, or titanium, depending on whether precedence should be given to mechanical strength or to thermal conductivity.

In the context of the present invention, in order to enable satisfactory confinement of the exothermic material and good heat exchanger to the brazing, it is advantageous for the ratio between the diameter of an individual chamber defined by a cup 250 or the disk 260 divided by its thickness to lie in the range 1.5 to 5, and preferably in the range 2 to 4, and this ratio is advantageously about 2.4.

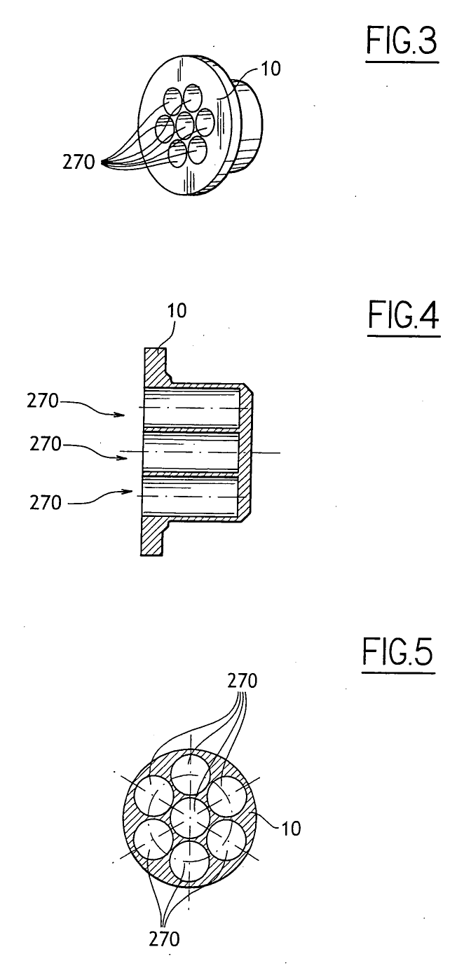

In a second embodiment of the present invention, shown in FIGS. 3 to 5, the chamber 20 is formed by a plurality of blind wells 270 formed in the main body 10.

The body 10 may be made of any suitable material, for example stainless steel, titanium, or any equivalent material, such as a copper/tungsten mixture, e.g. Cu28/W72.

Where appropriate, the wells 270 may be covered by a disk 260 like the disk shown in FIG. 2 and described above for the first embodiment.

Thus, accompanying FIGS. 3 to 5 show an embodiment of the present invention in which the chamber 20 is formed by seven wells each having a diameter of about 4.7 mm and a depth of about 11.5 mm (a central well is surrounded by a ring of six peripheral wells that are regularly distributed angularly) in a body of stainless steel that possesses an outside diameter of 16 mm and a height of 13.8 mm.

The ratio between the depth of a well 270 and its diameter is of the same order of magnitude as the ratio between the diameter of an individual chamber defined by a cup 250 or disk 260 and its thickness in the first embodiment. It thus lies in the range 1.5 to 5, and preferably in the range 2 to 4, and is advantageously about 2.4.

In typical but non-limiting manner, in the present invention, the exothermic mass is formed by a thermite, e.g. a mixture based on iron oxide (Fe₃O₄) and aluminum, while the brazing is made on the basis of gold and tin, or of cadmium and zinc.

Naturally, the present invention is not limited to the embodiments described above, but extends to any variant within the spirit of the invention.

The person skilled in the art will understand that the means proposed in the present invention enable the pyrotechnic composition to be kept confined during combustion in the volume in which it was initially charged, and to provide heat exchange with the walls of the chamber, particularly under conditions of microgravity.

What is claimed is:

1. A thermally-controlled actuator device of the type comprising a body, a part held stationary relative to the body by a low-melting point connection material, e.g. brazing or equivalent means, and a mass of exothermic material suitable for acting on command to give off intense heat energy suitable for melting the connection material so as to release the part relative to the body, wherein the exothermic material is housed in a chamber that is subdivided into a plurality of compartments suitable for confining said material in close thermal contact with the wall of the chamber.

2. A device according to claim 1, wherein the chamber is constituted by a housing formed in a main body and subdivided by a plurality of disks or cups.

3. A device according to claim 1, including a plurality of cups stacked at respective distances parallel to an end wall of the chamber, and a closure disk which covers the opening outline of the chamber.

4. A device according to claim 3, containing four cups and one disk.

5. A device according to claim 2, wherein the section of each cup and of the disk is complementary to the section of the chamber.

6. A device according to claim 2, wherein each cup is itself formed by a disk having a cylindrical collar at its periphery, with the height of the collar corresponding to the looked-for spacing between cups.

7. A device according to claim 2, wherein each cup and disk includes at least one through passage to allow initiation to be transmitted from an individual mass of exothermic material to an adjacent mass.

8. A device according to claim 7, wherein the through passages are angularly offset from one cup to another, so as to form a baffle for confining the exothermic material.

9. A device according to claim 2, wherein the cups or the disk are made of a material based on titanium or of a copper/tungsten mixture.

10. A device according to claim 2, wherein the ratio between the diameter of an individual chamber defined by a cup or a disk and its thickness lies in the range 1.5 to 5, and preferably in the range 2 to 4, advantageously being about 2.4.

11. A device according to claim 1, wherein the chamber is constituted by a plurality of wells formed in the main body.

12. A device according to claim 11, wherein the body in which the chamber is formed is itself made of stainless steel, titanium, or a copper/tungsten mixture.

13. A device according to claim 11, wherein the wells are covered by a disk including at least one through passage.

14. A device according to claim 11, wherein each well has a diameter of about 4.7 mm.

15. A device according to claim 11, wherein the ratio between the depth of the well and its diameter lies in the range 1.5 to 5, preferably in the range 2 to 4, and advantageously is about 2.4.
